(19) United States
(12) Patent Application Publication
(10) Pub. No.: US 2005/0270427 A1
(43) Pub. Date: Dec. 8, 2005

(54) Apparatus and method of controlling saturation of color image

(76) Inventors: Jea-won Kim, Seoul (KR); Jin-Sub Um, Suwon-si (KR); Moon-cheol Kim, Suwon-si (KR)

Correspondence Address: STANZIONE & KIM, LLP, 919 18TH STREET, N.W., SUITE 440, WASHINGTON, DC, 20006, US

(21) Appl. No.: 11/140,981

(22) Filed: Jun. 1, 2005

(30) Foreign Application Priority Data
Jun. 7, 2004 (KR) 2004-41352

(51) Int. Cl. H04N 9/64

(52) U.S. Cl. 348/652; 348/703

(57) ABSTRACT

A method of adaptively controlling saturation of an input image according to characteristics of the input image includes a saturation calculating unit to sequentially calculate saturation values of each pixel composing an input image, and to output the calculated saturation values, a histogram analysis unit to accumulate interval values, each interval value corresponding to the saturation value of pixel and being allocated to at least one of two intervals, to calculate a gain corresponding to a cumulative value of each interval, and to output the gain, and a total gain calculating unit to calculate a total gain from the transferred gains of the respective intervals.

### CROSS-REFERENCE TO RELATED APPLICATIONS

This application claims benefit under 35 U.S.C. § 119 from Korean Patent Application No. 2004-41352, filed on Jun. 7, 2004, the entire content of which is incorporated herein by reference.

### BACKGROUND OF THE INVENTION

1. Field of the Invention

The present general inventive concept relates to an apparatus and method of controlling saturation of a color image, and more specifically, to an apparatus and method of controlling saturation of an input color image, thereby providing an improved image quality.

2. Description of the Related Art

Generally, a conventional image processing apparatus has a problem in that color saturation is increased regardless of characteristics of an input image. For instance, if a user increases saturation of a background image of a scene displayed on a TV screen, a skin color of a character looks oversaturated and unnatural.

FIG. 1 is a schematic block diagram of a conventional color saturation control apparatus. The color saturation control apparatus includes a saturation calculating unit 100, a histogram calculating unit 102, a peak saturation calculating unit 104, a mean saturation calculating unit 106, a peak gain calculating unit 108, a mean gain calculating unit 110, a pattern gain calculating unit 112, an ultimate gain calculating unit 114, a color gain calculating unit 116, and a saturation control unit 118.

The saturation calculating unit 100 calculates saturation data S (x,y) of each pixel of an input image signal YCbCr. The histogram calculating unit 102 calculates a saturation histogram for all or part of pixels of the input image signal YCbCr according to the saturation data S (x,y) of each pixel provided from the saturation calculating unit 100. The peak saturation calculating unit 104 calculates a peak saturation value using the saturation histogram provided from the histogram calculating unit 102. The peak gain calculating unit 108 calculates a peak gain gₚₑₐₖ from the peak saturation value. The mean saturation calculating unit 106 calculates a mean saturation value using the saturation histogram provided from the histogram calculating unit 102. The mean gain calculating unit 110 calculates a mean gain gₘₑₐₙ from the mean saturation value.

The pattern gain calculating unit 112 detects a test pattern image and a monotone image such as a bird flying in blue sky or sunset from the input image signal YCbCr. Therefore, the pattern gain calculating unit 112 calculates a gain gₚ for the test pattern image or the monotone image. The gain gₚ from the pattern gain calculating unit 112 is then transferred to the ultimate gain calculating unit 114.

The color gain calculating unit 116 calculates a color gain g_{c} from the input image YCbCr depending on whether individual input pixel belongs to a skin color region. The color gain g_{c} from the color gain calculating unit 116 is transferred to the ultimate gain calculating unit 114. In addition, a gain g_{local} for each pixel from the saturation calculating unit 100 is transferred to the ultimate gain calculating unit 114.

Then the ultimate gain calculating unit 114 calculates an ultimate gain according to the received gains, such as the color gain g_{c}, the peak gain gₚₑₐₖ, the mean gain gₘₑₐₙ, the gain gₚ, and the gain g_{local} and transfers the ultimate gain g (x,y) to the saturation control unit 118. The saturation control unit 118 controls the saturation of the input image YCbCr using the ultimate gain g (x,y) transferred.

FIGS. 2A, 2B, 3A, and 3B illustrate hypothetical problems caused when peak saturation and mean saturation for the input image signal YCbCr in the color saturation control apparatus of FIG. 1 are applied to the saturation control of the input image signal YCbCr. Referring to FIGS. 2A and 2B, the hypothetical problem occurs when the mean saturation for the input image is used for the saturation control of the input image. Referring to FIGS. 3A and 3B, the hypothetical problem occurs when the peak saturation for the input image is used for the saturation control of the input image. FIGS. 2A through 3B illustrate images having a mean gain and a peak gain, respectively, according to pixel counts with respect to an image parameter S, e.g., saturation.

The mean saturation of images having the histograms shown in FIGS. 2A and 2B is uniform. However, a first image having the histogram shown in FIG. 2A has more values distributed around a mid saturation, and a second image having the histogram shown in FIG. 2B has more values distributed around a high and a low saturation. Therefore, the saturation for the first and second images with this histogram is controlled using the same gain.

The second image having the histogram shown in FIG. 2B has both high saturation and low saturation values. Thus, if a low saturation image in a grey tone is enhanced, the second image is severely distorted, and the same phenomenon occurs to a high saturation image. On the other hand, the first image having the histogram shown in FIG. 2A has mid saturation values. The image in the mid saturation is emphasized through a high gain in order to increase a saturation efficiency. That is, compared with the second image in low and high saturation, the first image in the mid saturation is more emphasized due to the high gain.

Third and fourth images having the histograms shown in FIGS. 3A and 3B tend to have the mid saturation values, but obtain a high gain from the peak saturation calculating unit 104 and the peak gain calculating unit 108 of FIG. 1 due to some of high saturation pixels. Although the first and third images having the histograms shown in FIGS. 2A through 3B seem to have similar mid saturation values, a relatively smaller gain is applied to the first or third image of FIG. 2A or 3A than the second or fourth image of FIG. 2B or 3B. Therefore, sharp and vivid color images cannot be obtained.

### SUMMARY OF THE INVENTION

The present general inventive concept provides an apparatus and method of controlling saturation of a color image according to characteristics of an input image signal in order to adaptively control the saturation of the input image signal.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a gain calculating apparatus including a saturation calculating unit to sequentially calculate saturation values of each pixel composing an input image, a histogram analysis unit to accumulate interval values, each interval value corresponding to the saturation value of pixel transferred from the saturation calculating unit and being allocated to a plurality of intervals, and to calculate a gain corresponding to a cumulative value of each interval, and a total gain calculating unit to calculate a total gain from the gains of the respective intervals that are transferred from the histogram analysis unit.

The foregoing and/or other aspects and advantages of the present general inventive concept may also be achieved by providing a method of calculating a gain, the method including sequentially calculating saturation values of each pixel composing an input image signal, accumulating interval values, each interval value corresponding to the saturation value of pixel transferred from the saturation calculating unit and being allocated to a plurality of intervals, calculating a gain corresponding to a cumulative value of each interval, and transferring the cumulative value, and calculating the total gain from the transferred gains of the respective intervals.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a related art saturation control apparatus;

FIGS. 2A and 2B are views illustrating images having an equal mean gain;

FIGS. 3A and 3B are views illustrating images having a peak gain;

FIG. 4 is a schematic block diagram illustrating a saturation control apparatus according to an embodiment of the present general inventive concept;

FIG. 5 is a view illustrating values transferred to a histogram analysis unit and a total gain calculating unit in the saturation control apparatus of FIG. 4;

FIG. 6 is a detailed view illustrating a histogram analysis unit and a total gain calculating unit in the saturation control apparatus of FIG. 4;

FIG. 7 is a graph illustrating input values output from the histogram analysis unit and allocated to one of a plurality of intervals in the saturation control apparatus of FIG. 4; and

FIG. 8 is a view illustrating a pattern function of a pattern gain calculating unit in the saturation control apparatus of FIG. 4.

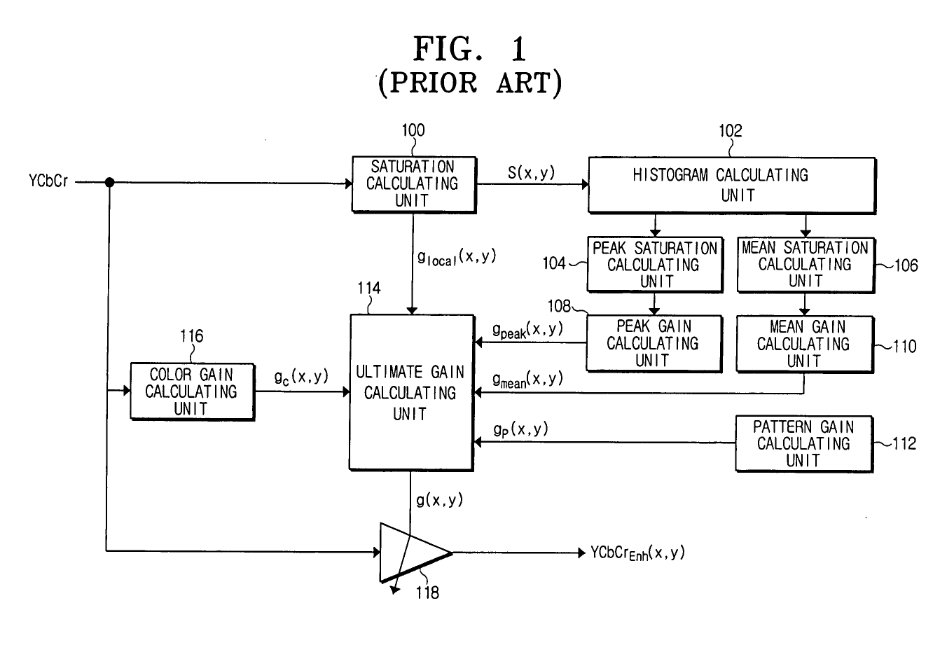

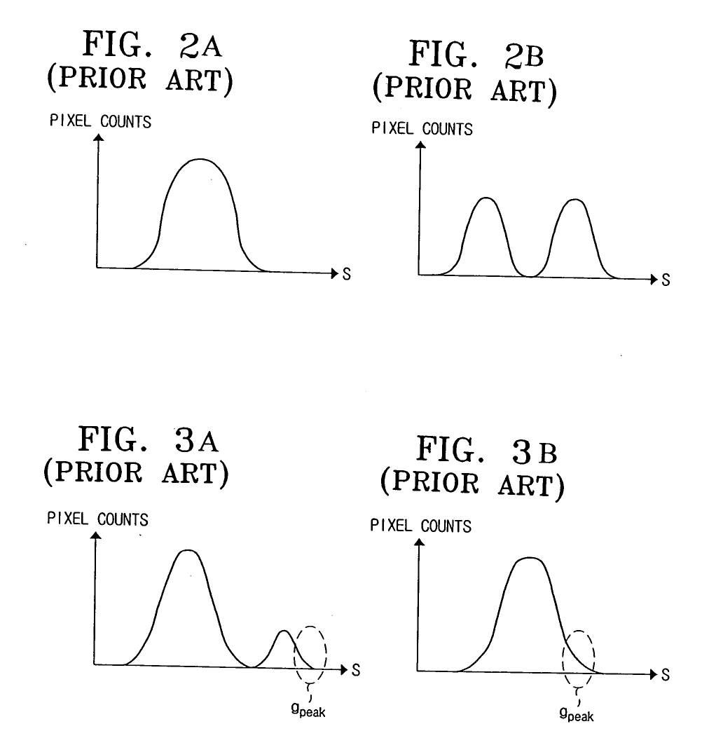

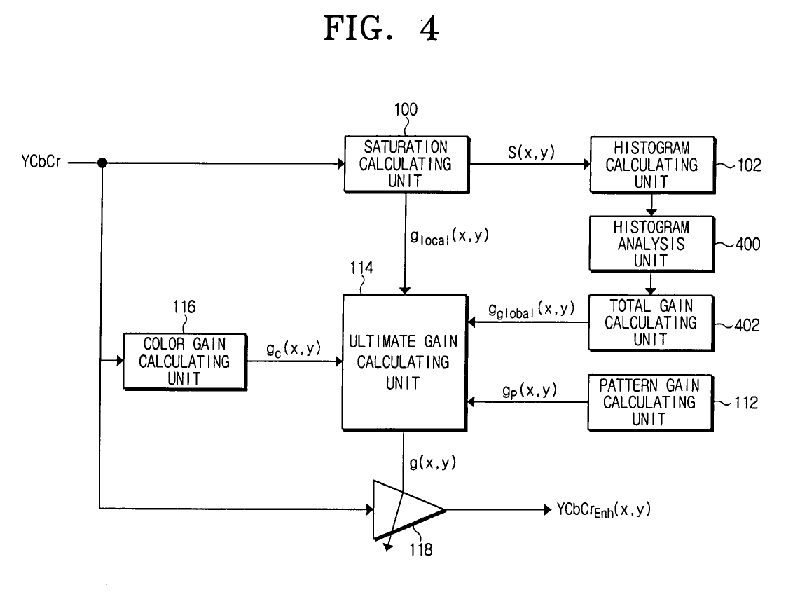

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 4 is a schematic block diagram illustrating a saturation control apparatus according to an embodiment of the present general inventive concept. The saturation control apparatus includes a saturation calculating unit 100, a histogram calculating unit 102, a histogram analysis unit 400, a total gain calculating unit 402, a pattern gain calculating unit 112, an ultimate gain calculating unit 114, a color gain calculating unit 116, and a saturation control unit 118. Although the saturation control apparatus can include other constitutions besides the above-described units, for convenience's sake only the constitution shown in FIG. 4 and operations thereof will be discussed hereinafter.

The saturation calculating unit 100 calculates a saturation value S (x,y) of each input pixel signal, for example, an input pixel signal YCbCr of an image signal. The saturation calculating unit 100 converts the input pixel signal YCbCr into an RGB signal as shown in <Equation 1> below.
(R,G,B)=(Y+a·Cr,Y+b·Cr+c·Cb,Y+d·Cb), <Equation 1>
wherein a, b, c and d are conversion coefficients. The saturation value S (x,y) is obtained by substituting the RGB signal into <Equation 2>]below.

$$S = \frac{Max [ R , G , B ] - min [ R , G , B ]}{Max [ R , G , B ] + min [ R , G , B ]} , \qquad < Equation 2 >$$

wherein S is a normalized saturation value between 0 and 1. The saturation value S (x,y) calculated in the saturation calculating unit 100 is transferred to the histogram calculating unit 102.

The histogram calculating unit 102 obtains a saturation histogram for all or part of pixels from the saturation value S (x,y) for each individual pixel provided from the saturation calculating unit 100.

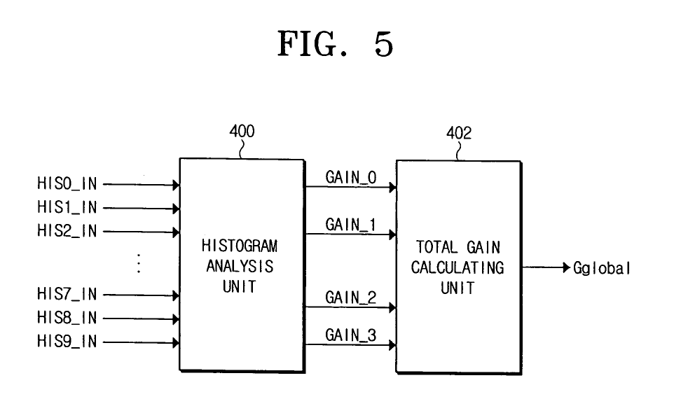

FIG. 5 illustrates a case where saturation values that are transferable from the histogram calculating unit 102 are allocated into a plurality of first intervals, for example, ten intervals (histograms). For example, a frame or field unit of the image signal can be divided into the ten intervals according to an image parameter, and the saturation values are allocated into corresponding ones of the ten intervals. The ten intervals are HIS0_IN through HIS9_IN. That is, the histogram calculating unit 102 allocates a saturation value to a corresponding one of the ten intervals. An output value from the histogram calculating unit 102 is transferred to the histogram analysis unit 400.

The histogram analysis unit 400 accumulates the transferred values in frame unit so that the transferred values forming the frame unit are allocated into the corresponding ones of the ten intervals. The histogram analysis unit 400 allocates the transferred values of the ten intervals into a plurality of second intervals each including at least one of the ten intervals. For example, since the number of the plurality of the second intervals is smaller than that of the first intervals, i.e., ten intervals, the transferred value of one of the ten intervals can be allocated into adjacent second intervals. That is, the transferred value of one of the ten intervals can be accumulated or counted in the adjacent second intervals. The histogram analysis unit 400 calculates a gain for each interval according to the number of the counted transferred values. For instance, in FIG. 5, the histogram analysis unit 400 allocates the transferred values into four intervals when the number of the plurality of second intervals is four, and outputs a gain for each interval. The gains for the respective second intervals are GAIN_0 through GAIN_3.

Each of the gains outputted from the histogram analysis unit 400 is transferred to the total gain calculating unit 402. Then, the total gain calculating unit 402 calculates a total gain from the gains transferred.

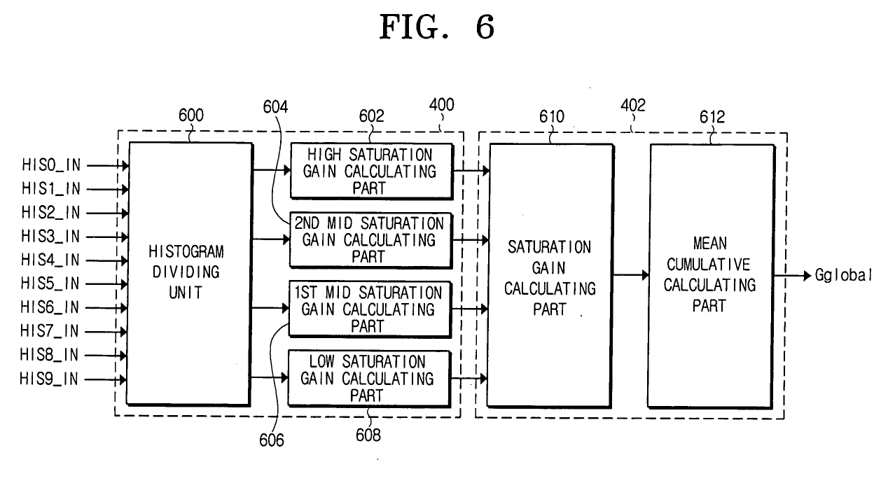

FIG. 6 illustrates the histogram analysis unit 400 and the total gain calculating unit 402 in detail. The histogram analysis unit 400 includes a histogram dividing part 600, and saturation gain calculating parts 602 through 608. The total gain calculating unit 402 includes a saturation gain calculating part 610 and a mean cumulative calculating part 612. More details on each constitution will be provided below.

The histogram analysis unit 400 accumulates values transferred from the histogram calculating unit 102.

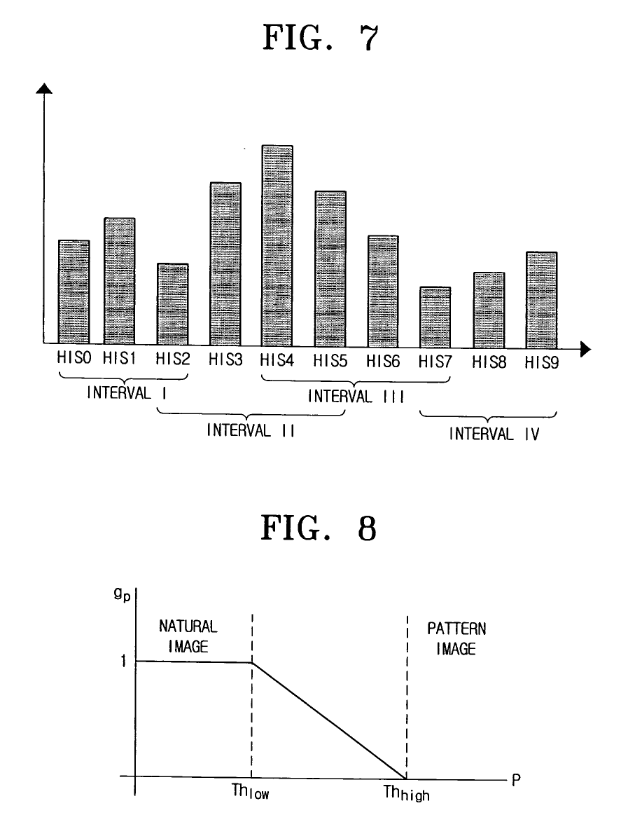

FIG. 7 graphically illustrates that the histogram analysis unit 400 accumulates the transferred values for one frame. According to FIG. 7, the histogram analysis unit 400 received a value corresponding to the 5^{th} interval HIS4_IN most, and a value corresponding to the 8^{th} interval HIS7_IN least.

The histogram dividing part 600 divides the transferred values into a plurality of intervals, and accumulates them in each interval. <Table 1> below illustrates that the histogram dividing part 600 accumulates the transferred values in each second interval.

TABLE 1

| | |
|---|---|
| Interval I (low saturation interval) | HIS0_IN through HIS2_IN |
| Interval II (1^{st} mid saturation interval) | HIS2_IN through HIS5_IN |
| Interval III (2^{nd} mid saturation interval) | HIS4_IN through HIS7_IN |
| Interval IV (high saturation interval) | HIS7_IN through HIS9_IN |

To remove a boundary effect, the histogram dividing part 600 sets the second intervals in such a manner that they overlap each other. The histogram dividing part 600 transfers the cumulative values in each interval to corresponding ones of the saturation gain calculating parts 602 through 608. For instance, the cumulative value in the interval IV is transferred to the high saturation gain calculating part 602, and the cumulative value in the interval III is transferred to the 2^{nd} mid saturation gain calculating part 604. Likewise, the cumulative value in the interval II is transferred to the 1^{st} mid saturation gain calculating part 606, and the cumulative value in the interval I is transferred to the low saturation gain calculating part 608.

Each of the saturation gain calculating parts 602 through 608 calculates a saturation gain of each interval using the transferred cumulative value. <Equation 3> below formulates the operation performed in each of the saturation gain calculating parts 602 through 608.
Distribution of frequency (i)=(Cumulative value of interval (i))/(Total cumulative value) where 0≦i≦3. [Equation 3]

Each of the saturation gain calculating parts 602 through 608 stores a gain for the distribution of frequency. <Table 2> below shows the gains for the distribution of frequency that are stored in the saturation gain calculating parts 602 through 608, respectively.

TABLE 2

| | Distribution of frequency | | | | |
|---|---|---|---|---|---|
| | ≧75% | ≧50% | ≧25% | ≧12.5% | ≦12.5% |
| Low satu- | 32 | 96 | 160 | 224 | 225 |
| ration gain | | | | | |
| 1^{st} mid satu- | 255 | 192 | 128 | 64 | 0 |
| ration gain | | | | | |
| 2^{nd} mid satu- | 224 | 192 | 96 | 48 | 0 |
| ration gain | | | | | |
| High satu- | 32 | 96 | 160 | 224 | 225 |
| ration gain | | | | | |

As shown in the <Table 2>, saturation enhancement is supposed to be low in a case of either high or low saturation images, or images having high and low saturation. Therefore, the lower the distribution of frequency is, the higher the gain value is. In a case of an image having mid saturation, on the other hand, the saturation enhancement should be relatively high. Thus, the higher the distribution of frequency is, the higher the gain value is. The low saturation gain is denoted as GAIN_1, and the high saturation gain is denoted as GAIN_3. The 1^{st} mid saturation gain is denoted as GAIN_1, and the 2^{nd} mid saturation gain is denoted as GAIN_2.

The gains that are calculated in the saturation gain calculating parts 602 through 608 are transferred to the saturation gain calculating part 610. Then, the saturation gain calculating part 610 calculates a total gain from the transferred gains. <Equation 4> below formulates the operation performed in the saturation gain calculating part 610.

$${g}_{total} ( x , y ) = \frac{\begin{matrix}min ( GAIN\_ 0 , GAIN\_ 3 ) + \\ max ( GAIN\_ 1 , GAIN\_ 2 )\end{matrix}}{2} , \qquad [ Equation 4 ]$$

wherein gₜₒₜₐₗ(x,y) indicates a total gain outputted from the saturation gain calculating part 610. The total gain outputted from the saturation gain calculating part 610 is transferred to the mean cumulative calculating part 612.

The mean cumulative calculating part 612 accumulates the total gains gₜₒₜₐₗ(x,y) from the saturation gain calculating part 610 for several frames, and outputs a mean thereof. In this manner, the mean cumulative calculating part 612 is able to accumulate many frames, given that there are only small changes in the image screen. The output g_{global}(x,y) from the mean cumulative calculating part 612 is then transferred to the ultimate gain calculating unit 114.

In fact, there are other gain values that are transferred to the ultimate gain calculating unit 114. According to FIG. 4, the ultimate gain calculating unit 114 receives gain values not only from the total gain calculating unit 402 but also from the saturation calculating unit 100, the color gain calculating unit 116, and the pattern gain calculating unit 112.

The saturation calculation unit 100 calculates a local gain g_{local} (x,y) for each individual pixel using the saturation value of each pixel and a gain function. According to the gain function, a pixel having a high saturation has a small gain value. As such, gamut mapping can be minimized, a gamut mapping block (this often causes a problem in color image processing) can be avoided, and a color change due to the gamut mapping can be prevented. If there is no restriction for a memory, the local gains g_{local} (x,y) for each pixel from the saturation calculating unit 100 can be stored in a separate memory.

The pattern gain calculating unit 112 detects a text image or a monotone image from the input pixel signal YCbCr or the RGB signal, and reflects the detected image to the gain. The test image or the monotone image exhibits a relatively high saturation component, compared to natural images. As shown in <Equation 5> below, the pattern gain calculating unit 112 calculates an absolute value of a difference between the number of pixels of two neighboring saturation values in a histogram interval, and averages the absolute value to output an average value P.
P=1/N|H(i)−H(i+1)| [Equation 5]
where H(i) indicates the number of pixels of the i-th saturation.

The pattern gain calculating unit 112 calculates a pattern gain gₚ(x,y) using the average value P from the <Equation 5> and the pattern gain function of FIG. 8. If the average value P is less than TH_{Low} it corresponds to the natural image, and if the average value P is greater than TH_{High} it corresponds to the test image. If the average value P corresponds to the natural image, the pattern gain calculating unit 112 designates the pattern gain gₚ(x,y) to 1, and if the average value P corresponds to the test image, the pattern gain calculating unit 112 designates the pattern gain gₚ(x,y) to 0. In this manner, the saturation control is not actually performed on the original input image.

Further, if an input image has the average value P between TH_{Low} and TH_{High}, the image corresponds to the monotone image. Since an excessive increase in chroma deteriorates the image quality, the pattern gain calculating unit 112 calculates the pattern gain gₚ(x,y) inversely proportional to the P. The pattern gain gₚ(x,y) from the pattern gain calculating unit 112 is then transferred to the ultimate gain calculating unit 114.

The color gain calculating unit 116 calculates a color gain g_{c}(x,y) depending on whether each individual pixel of an input image belongs to a skin color region. To decide whether an input pixel belongs to the skin color region, the color gain calculating unit 116 may determine whether a YCbCr color space is located in the skin color region. A process of determining whether the YCbCr color space is located in the skin color region will be omitted here since the determining process is well known. The color gain gₚ(x,y) from the color gain calculating unit 116 is transferred to the ultimate gain calculating unit 114.

The ultimate gain calculating unit 114 calculates an ultimate gain g(x, y) using the transferred gains. <Equation 6> below formulates the operation performed in the ultimate gain calculating unit 114.
g(x,y)=1+g_{gloval}(x,y)·gₚ(x,y)·g_{local}(x,y)·g_{c}(x,y), [Equation 6]
wherein g(x, y) indicates the ultimate gain calculated in the ultimate gain calculating unit 114. According to FIG. 4, a total of four gains are transferred to the ultimate gain calculating unit 114, but this can be changed any time depending on how the user sets up. For instance, it can be set up that at least one of the four gains is transferred to the ultimate gain calculating unit 114. In this case, the user should make sure that the g_{global}(x, y) is always transferred to the ultimate gain calculating unit 114.

The ultimate gain g(x, y) from the ultimate gain calculating unit 114 is transferred to the saturation control unit 118. Then, the saturation control unit 118 controls the saturating of an input image using the ultimate gain g(x, y) provided from the ultimate gain calculating unit 114. <Equation 7> below formulates the operation performed on the saturation control unit 118.
YCbCr_{EnH}(x,y)=(Y(x,y), g(x,y)·Cb(x,y), g(x,y)·Cr(x,y)) [Equation 7]

As described above, a problem occurring when a mean gain and a peak gain of an existing image are applied to a conventional saturation control process can be solved by dividing the input image according to saturations and allocating different gains to the saturations. As a result, sharp and vivid color images can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A gain calculating apparatus usable with an image processing apparatus, comprising:
a saturation calculating unit to sequentially calculate saturation values of pixels composing an input image signal;
a histogram analysis unit to allocate and accumulate each of the saturation values into at least one of a plurality of intervals, and to calculate gains each corresponding to the saturation values accumulated in the respective intervals; and
a total gain calculating unit to calculate a total gain from the gains of the respective intervals that are transferred from the histogram analysis unit so that saturation of the input image signal is controlled according to the total gain.

2. The apparatus according to claim 1, further comprising:
a histogram calculating unit to allocate the saturation values of respective pixels output from the saturation calculating unit into a plurality of sub-intervals,
wherein the histogram analysis unit allocates the allocated saturation values of the respective sub-interval into corresponding ones of the intervals.

3. The apparatus according to claim 2, wherein the histogram analysis unit comprises:
a histogram dividing part to allocate and accumulate the allocated saturation values of the sub-intervals into the corresponding ones of the intervals; and
at least two saturation gain calculating parts to calculate the gains corresponding to the accumulated saturation values of the respective intervals.

4. The apparatus according to claim 3, wherein each sub-interval and each interval have a first range and a second range, respectively, and the histogram dividing part sequentially allocates the saturation values of the sub-intervals into the respective intervals.

5. The apparatus according to claim 3, wherein the histogram dividing part allocates one of the saturation values located at a boundary of two neighboring ones of the intervals into both of the two neighboring intervals.

6. The apparatus according to claim 3, wherein each of the at least two saturation gain calculating parts calculates a corresponding one of the gains using a ratio of all of the accumulated saturation values of the intervals to a corresponding one of the accumulated saturation values of a corresponding one of the intervals.

7. The apparatus according to claim 6, wherein the gains comprise a low gain and a high gain, the saturation values comprise a high saturation value, a low saturation value, and a mid saturation value, and the at least two saturation gain calculating parts allocated with the high saturation value or the low saturation value outputs the low gain if the ratio is a lfirst value, and the at least two saturation gain calculating part allocated with the mid saturation value outputs the high gain if the ratio is a second value.

8. The apparatus according to claim 2, wherein the total gain comprises a first total gain of a current frame of the input image signal and a second total gain of a previous frame of the input image signal, and the total gain calculating unit comprises:
a saturation gain calculating part to calculate the total gain from the gains of the respective intervals that are transferred from the histogram analysis unit; and
a mean cumulative calculating part to accumulate the first and second total gains from the saturation gain calculating part, and to output a mean value of the accumulated total gains.

9. The apparatus according to claim 8, wherein the gains comprise a lower gain and a higher rain, the intervals comprise a low saturation interval, a high saturation interval, and a mid saturation interval, and the saturation gain calculating part calculates a sum of the lower gain from the gains of the low saturation interval and the high saturation interval, and the high gain from the gains of at least one mid saturation interval to output the total gain.

10. An image processing apparatus comprising:
a gain calculating apparatus comprising,
a saturation calculating unit to receive an input image signal, to calculate saturation values of pixels of the input image signal, and to allocate the saturation values into a plurality of first intervals each having a first range,
a histogram analysis unit to allocate and accumulate each of the respective saturation values of the first intervals into at least one of a plurality of second intervals each having a second range greater than the first range, and to calculate gains each corresponding to the saturation values accumulated in the respective second intervals, and
a total gain calculating unit to calculate a total gain from the gains of the respective intervals that are transferred from the histogram analysis unit; and
a saturation control unit to control saturation of the input image signal according to the total gain.

11. The image processing apparatus according to claim 10, further comprising:
an ultimate gain calculating unit to generate an ultimate gain according to the total gain and a predetermined gain representing a characteristic of the input image signal,
wherein the saturation control unit controls the saturation of the input image signal according to the ultimate gain.

12. The image processing apparatus according to claim 11, wherein the predetermined gain comprises at least one of a color gain, a pattern gain, and a local gain of the input image signal.

13. The image processing apparatus according to claim 10, wherein the first intervals are located within a frame unit of the input image signal according to an image parameter.

14. The image processing apparatus according to claim 13, wherein the image parameter comprises saturation having a range divided into the first intervals, and the first range of the first intervals are divided into the second intervals, and the range is smaller than the first and second ranges.

15. The image processing apparatus according to claim 10, wherein the first range is larger than the second range.

16. The image processing apparatus according to claim 10, wherein at least one of the first intervals correspond to at least two of the second intervals.

17. The image processing apparatus according to claim 10, wherein the second intervals comprises two adjacent second intervals to overlap each other.

18. The image processing apparatus according to claim 10, wherein at least one of the saturation values corresponding to the first intervals is allocated and accumulated into at least two of the second intervals.

19. The image processing apparatus according to claim 10, wherein the number of the first interval is larger than that of the second intervals.

20. The image processing apparatus according to claim 10, wherein the first intervals comprise first, second, third, and fourth saturation groups each having at least different one of the first intervals, and the second intervals comprise an interval one into which the saturation values of the first group of the first intervals are allocated and accumulated, an interval two into which the saturation values of a portion of the second saturation group of the first intervals, a second saturation group of the first intervals, and a portion of the third saturation group of the first intervals are allocated and accumulated, an interval three into which the saturation values of the third saturation group of the first intervals are allocated and accumulated, and an interval four into which the saturation values of a portion of the third saturation group of the first intervals and the fourth saturation group of the first intervals are allocated and accumulated.

21. The image processing apparatus according to claim 10, wherein if the number of the first intervals is ten, the first intervals comprise first through tenth sub-intervals, and if the number of the second intervals is four, the second intervals comprise an interval one into which the saturation values corresponding to the first through third sub-intervals are allocated and accumulated, an interval two into which the saturation values corresponding to the third through sixth sub-intervals are allocated and accumulated, an interval three into which the saturation values corresponding to the fifth through eight sub-intervals are allocated and accumulated, and an interval four into which the saturation values corresponding to the eight through tenth sub-intervals are allocated and accumulated.

22. A method of calculating a gain in an image processing apparatus, the method comprising:
sequentially calculating saturation values of pixels composing an input image signal;
allocating and accumulating each of the saturation values into at least one of a plurality of intervals, and calculating gains each corresponding to the saturation values accumulated in the respective intervals; and
calculating a total gain from the gains of the respective intervals.

23. The method according to claim 22, wherein the calculation of the gains comprises:
allocating the saturation values into sub-intervals, and accumulating and transferring the allocated interval values of the sub-intervals into corresponding ones of the intervals; and
calculating the gains corresponding to the accumulated saturation values of the respective intervals.

24. The method according to claim 23, wherein each sub-interval and each interval have a first range and a second range, respectively, and the allocating of the saturation values of the respective sub-intervals comprises sequentially allocating the saturation values of the sub-intervals into at least two of the intervals.

25. The method according to claim 24, wherein the allocating of the saturation values comprises allocating the saturation values located at a boundary of two neighboring ones of the intervals into two neighboring intervals.

26. The method according to claim 23, wherein each of the gains corresponding to the accumulated saturation values of the respective intervals comprises calculating each gain according to a ratio of all of the accumulated saturation values of the intervals to the saturation values of a corresponding one of the accumulated saturation values.

27. The method according to claim 26, wherein the calculating of the each gain comprises:
if the ratio is a first value and the corresponding interval is allocated with a high saturation value or a low saturation value, a low gain is calculated: and
if the ratio is a second value and the corresponding interval is allocated with a mid saturation value, a high gain is calculated.

28. The method according to claim 23, wherein the calculating of the total gain comprises:
calculating the total gain from the gains for the respective intervals transferred; and
accumulating the total gains for a predetermined amount of time, and outputting a mean value of the accumulated total gains.

29. The method according to claim 28, wherein the gains comprises a low gain and a high gain, the saturation values comprise a low, a high, and a mid saturation interval, and the calculating of the total gain comprises adding the lower gain from the gains of the low saturation interval and the high saturation interval, and the high gain from the gains of the mid saturation interval.
